(19) United States
(12) Patent Application Publication
(10) Pub. No.: US 2021/0059471 A1
(43) Pub. Date: Mar. 4, 2021

(54) Portable Outdoor Grill and Method for Cooking Outdoors in Windy Conditions

(71) Applicant: James Davenport Hundley, JR., Wilmington, NC (US)

(72) Inventor: James Davenport Hundley, JR., Wilmington, NC (US)

(21) Appl. No.: 16/556,151

(22) Filed: Aug. 29, 2019

(51) Int. Cl. A47J 37/07

(52) U.S. Cl. CPC A47J 37/0763; F24B 1/191; A47J 37/0731; A47J 37/0704

(57) ABSTRACT

A portable outdoor grill and method for cooking in windy outdoor environments protects food on a grill grate from wind-blown debris by retaining the grill grate at an offset position away from a rim that forms at an open grill end of the portable outdoor grill. The food is circumferentially surrounded by the sidewalls at the grill end of the portable outdoor grill. The heat fuel is circumferentially surrounded by the sidewalls at the base end of the grill. Multiple fastening apertures and grate support fasteners enable height adjustability of the grill grate along the length of the housing. Multiple vent apertures form in the sidewalls to enable air circulation for enhanced grilling. Insulated handles facilitate gripping and manipulation of the portable outdoor grill. A Z-shaped spatula facilitates access to the offset grill grate below the rim.

### FIELD

The present invention generally relates to a portable outdoor grill and method for cooking in windy outdoor environments.

### SUMMARY

The present invention generally relates to a portable outdoor grill and method for cooking in windy outdoor environments. More so, a portable outdoor grill protects food on a grill grate from flying debris by retaining the grill grate in a predetermined offset position from the rim that forms at the open end of the grill housing; whereby the portable outdoor grill provides a cylindrical housing defined by an open base end and an open grill end terminating at a rim, and further including a sidewall extending between the open ends; whereby a grill grate, for supporting food, is sized and dimensioned to position perpendicularly across the sidewalls, the grill grate being offset from the rim a predetermined distance so as to protect food from debris that is blown across the open grill end; whereby the housing is sufficiently portable to enable the open base end of the housing to position over any number of ground surfaces containing heating fuel used to radiate heat towards the food on the grill grate; whereby a plurality of fastening apertures form in the sidewalls of the housing for receiving grate support fasteners that support the grill grate at a plurality of longitudinal positions along the length of the housing; whereby the user can select which among the plurality of support fasteners to place the grate depending on the wind intensity; whereby a plurality of vent apertures form in the sidewall to enable circulation of air within the sidewalls of the housing; whereby a ventilation control assembly is slidably attached to the interior sidewall of the housing controls the degree of desired ventilation; whereby an insulated handle facilitates gripped manipulation of the portable outdoor grill; and whereby a Z-shaped spatula facilitates access to the offset grill grate below the rim.

### BRIEF DESCRIPTION OF THE DRAWINGS

The invention will now be described, by way of example, with reference to the accompanying drawings, in which:

FIG. 1 illustrates a front perspective view of an exemplary portable outdoor grill, in accordance with an embodiment of the present invention;

FIG. 2 illustrates a bottom view of the portable outdoor grill shown in FIG. 1, showing the grill grate, in accordance with an embodiment of the present invention;

FIG. 3 illustrates a top view of the portable outdoor grill shown in FIG. 1, in accordance with an embodiment of the present invention;

FIG. 4 illustrates a lower angle view of the portable outdoor grill shown in FIG. 1, in accordance with an embodiment of the present invention;

FIG. 5 illustrates an elevated side view of the sidewall of the housing of the portable outdoor grill shown in FIG. 1, in accordance with an embodiment of the present invention; and

FIG. 6 illustrates a flowchart diagram of an exemplary method for grilling in windy conditions with a portable outdoor grill, in accordance with an embodiment of the present invention.

Like reference numerals refer to like parts throughout the various views of the drawings.

### DETAILED DESCRIPTION

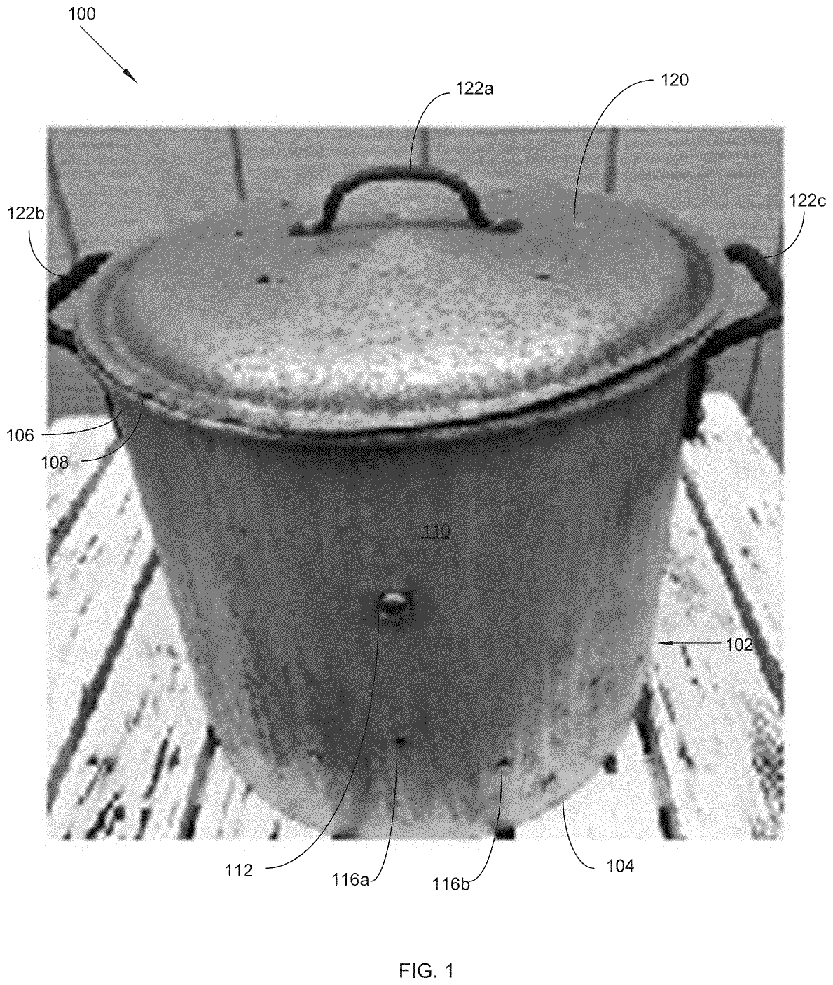

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention, presented in FIGS. 1-6, a portable outdoor grill 100 and method 200 for cooking in windy outdoor environments helps protect food on a grill grate 118 from wind-blown debris by retaining the grill grate 118 at a predetermined offset position away from a rim 108 that forms at an open grill end 106 of the portable outdoor grill 100. In this manner, the food is circumferentially surrounded by the sidewalls at the grill end 106 of the portable outdoor grill 100. The heat fuel is circumferentially surrounded by the sidewalls 110 at the base end 104 of the portable outdoor grill 100. In this manner, the heating fuel remains protected behind the sidewall 110 at the base end 104 of the portable outdoor grill 100.

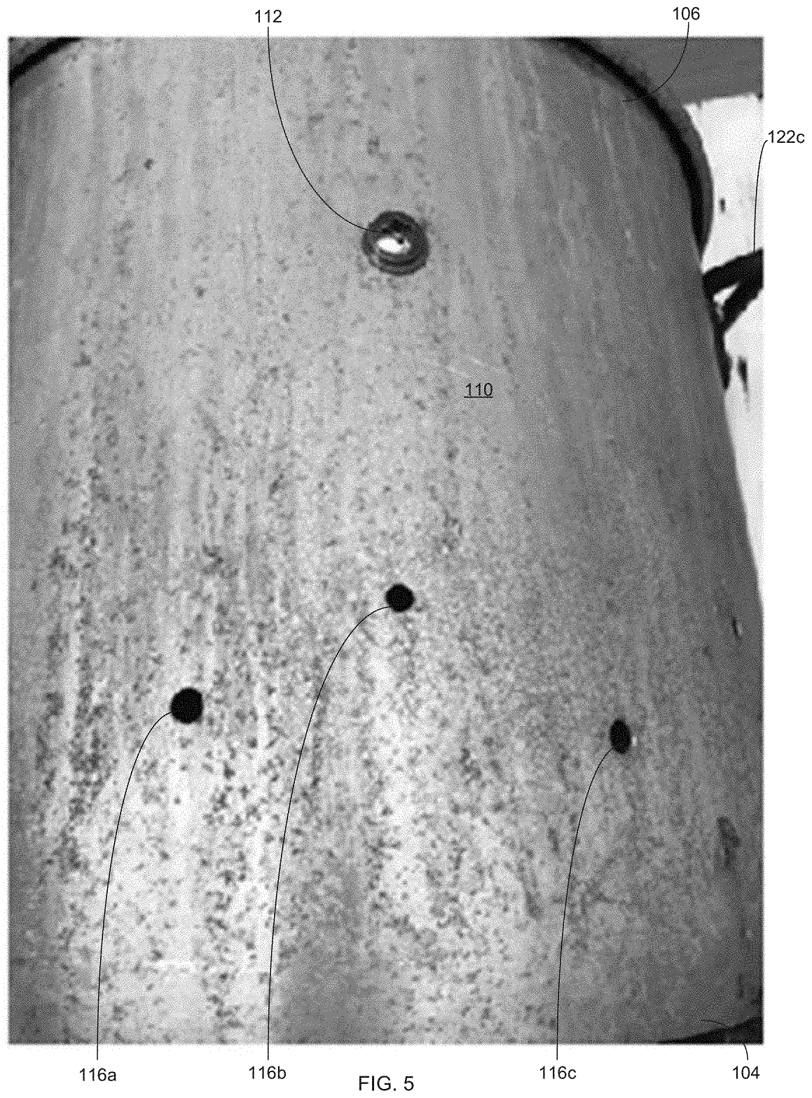

As best illustrated in the embodiment of FIGS. 1 and 5, a plurality of fastening apertures 112 that form in the sidewall, and grate support fasteners 114a-d passing through the fastening apertures, enable height adjustability of the grill grate 118 along the length of the sidewall 110. A user can conveniently change the height of the grate 118 in the cylindrical housing 102 depending on the environmental conditions. Multiple vent apertures 116a-c form in the sidewall 110 to enable air circulation, thereby enhancing the grilling process. At least one insulated handle 122a-c facilitates manipulation and mobility of the portable outdoor grill 100. To help in accessing the food on the offset grill grate 118, a generally Z-shaped spatula facilitates access to the grill grate 118 below the rim 108. Furthermore, a ventilation control assembly slidably affixed to the interior sidewall may be provided (not shown). In some embodiments, ventilation control assembly may comprise a plate conforming to the shape of the sidewall and covering one or more of the vent apertures 116a-c as it is manipulated by the user. Plate and interior sidewall may be fitted with a track assembly to promote uniform and substantially linear motion of the plate as it is manipulated.

In one aspect, the portable outdoor grill 100, comprises:
a cylindrical housing 102 defined by an open base end 104 and an open grill end 106 terminating at a rim 108, the housing 102 further defined by a sidewall 110 extending between the open ends 104, 106, the sidewall 110 defined by a plurality of fastening apertures 112 disposed along different longitudinal positions along the length of the housing 102, the sidewall 110 further defined by a plurality of vent apertures 116a-c spaced a predetermined distance from one another and in a pattern that enables efficient passage of air through the sidewall 110 exposing a heating fuel to oxygen;
whereby the open base end 104 of the housing 102 concentrically positions over and substantially encloses a heating fuel for directing radiated heat towards the open grill end 106;
a grill grate 118 perpendicularly disposed across the sidewall 110, the grill grate 118 being offset a predetermined protected distance from the rim 108;
a plurality of grate support fasteners (or supports) 114a-d passing through the fastening apertures 112 for supporting the grill grate 118 at different longitudinal positions along the length of the housing 102;
a lid 120 detachably covering the open grill end 106 of the housing 102;
at least one insulated handle 122a-c facilitating gripped manipulation of the portable outdoor grill 100; and
a generally Z-shaped spatula facilitating access to the offset grill grate 118.

In another aspect, the housing 102 is fabricated from a noncorrosive material.

In another aspect, the grill grate 118 is positioned about one-third of the length of the sidewall 110 from the open grill end 106 of the housing 102.

In another aspect, the housing 102 is about 12″ long and has a diameter of about 13½″.

In another aspect, the grill grate 118 is 4″ from the rim 108, and 8″ from the open base end 104.

In another aspect, the fastening and vent apertures 112, 116a-c are circumferentially disposed around the sidewall 110.

In another aspect, the heating fuel positions in a pit.

In another aspect, the heating fuel comprises charcoal.

In another aspect, the one insulated handle 122a positions on the lid 120, and two insulated handles 122b, 122c position on the sidewall 110.

In another aspect, the interior or exterior sidewall 110 of cylindrical housing 102 is fitted with a ventilation control assembly.

In another aspect, the ventilation control assembly may comprise a plate slidably engaged and conformed to the sidewall 110 and wherein said plate and sidewall 110 further comprise a track assembly for controlled movement of plate across the sidewall surface.

One objective of the present invention is to protect food on a grill grate 118 from debris, such as sand, that is blown by the wind.

Another objective is to offset the grill grate 118 a predetermined distance below the rim 108 of the open grill end 106;

Another objective is to offset the grill grate to about 4″ below the rim 108 of the open grill end 106.

Another objective is to enable the grill grate 118 to be height adjusted at different longitudinal positions along the length of the housing 102 through use of grate support fasteners 114a-d passing through the fastening apertures 112.

Another objective is to provide a portable housing 102 that can easily be carried to multiple pits containing charcoal.

Another objective is to protect the heating fuel from the wind by the position of the sidewall 110 at the open base end 104 of the housing 102.

Another objective is to provide vent apertures 116a-c that allow for air circulation inside the housing 102.

Another objective is to control the degree of air flow through vent apertures 116a-c by ventilation control assembly.

Another objective is to provide an inexpensive to manufacture portable outdoor grill 100.

Those skilled in the art will recognize that outdoor cooking devices, such as barbecue grills, are well known for their ability to provide naturally flavored food. Barbecue grills of many shapes and sizes have been known and used for many years. Typically, the barbecue grill is fueled by an open fire consisting of wood or coal wherein the food drippings help in the flavoring of the food. Alternatively, the cooking device can be fueled by a gas burner.

Often, portable grills that use fuel sources, such as charcoal or gas, are generally made of inexpensive steel. These grills are susceptible to the problem of wind and blowing sand when grilling outdoors. Typically, initiating a fire within a charcoal or gas grill is difficult in windy, sand-blown areas like a beach or ocean setting. In many grill designs, the depth of the grill grate relative to the top rim of the grill body is not sufficiently deep to inhibit blowing sand, dust, etc. from engaging the food that is being cooked on the grill grate.

The present portable outdoor grill 100 provides a protective cylindrical housing 102 that retains a grill grate 118 and the heating fuel in an offset, recessed position within the housing 102 to protect from the wind and wind-blown debris.

As referenced in FIG. 1, the portable outdoor grill 100 comprises a cylindrical housing 102 that forms the circumferential enclosure for grilling the food, and generating the radiant heat from the flat ground surface, a pit or depression containing heat fuel. In one embodiment, the housing 102 may include a barrel-type grill that surrounds a grill grate 118 and food within a cylindrical sidewall 110. The cylindrical shape of the sidewall 110 is useful for guiding the placement of the heat fuel towards the base end 104, and positioning the base end 104 in the ground or a shallow hole that has been dug up to place the heat fuel. The cylindrical shape of the sidewall 110 also provides stability and forms an aerodynamic barrier to windy environments.

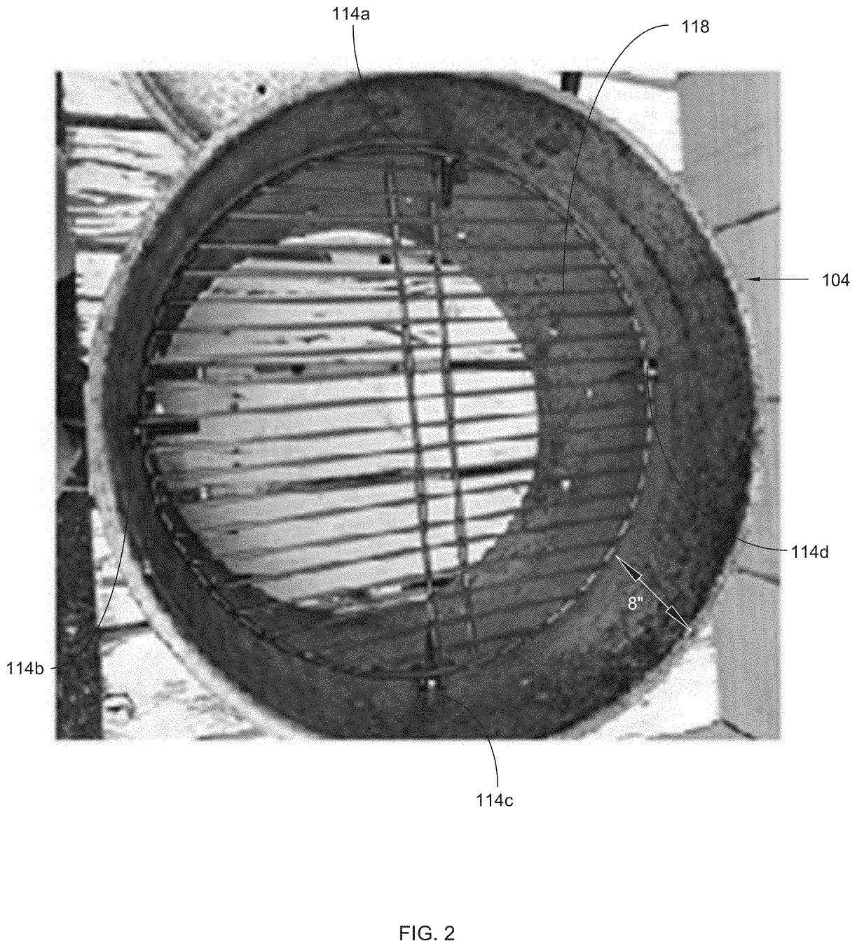

In one non-limiting embodiment shown in FIG. 2, the housing 102 is defined by an open base end 104 that forms the lowest point of the housing 102. The heat fuel is substantially encapsulated by the base end 104 protecting the heat fuel from the wind and elements. Further, once grilling is complete, the portable outdoor grill 100 is easily lifted with at least one insulated handle 1122a-c, leaving the heat fuel in place on the ground. It is significant to note that since charcoal is biodegradable, it is safe to leave the charcoal behind on the beach which makes for easy cleanup.

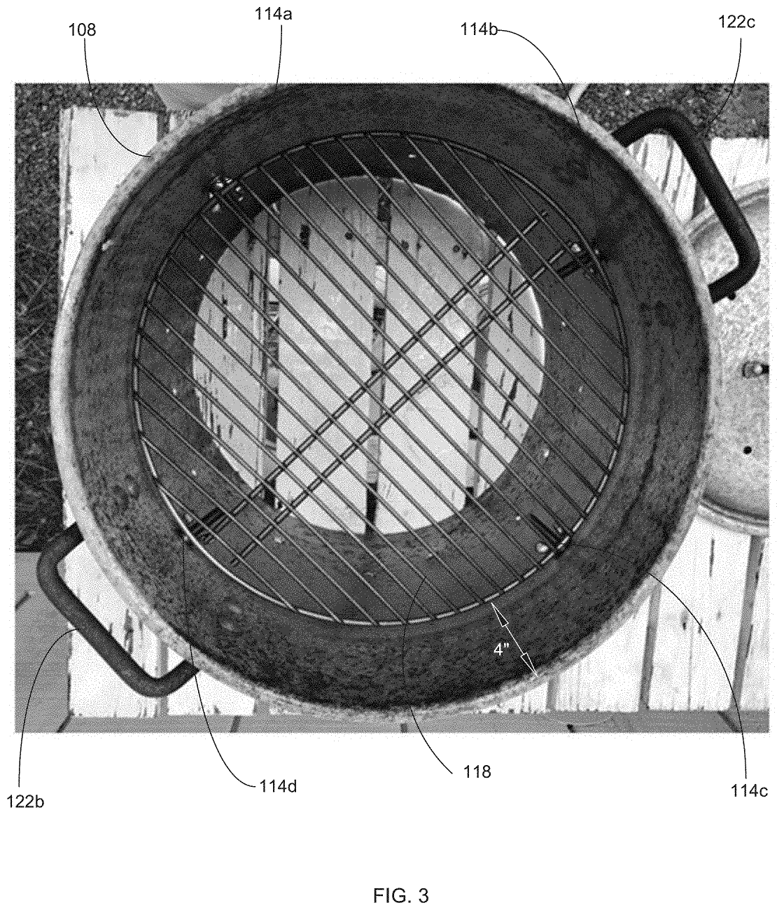

Turning now to FIG. 3, the housing 102 is also defined by an open grill end 106 that terminates at a rim 108. The grill end 106 forms the uppermost end of the housing 102. The food is accessed and manipulated through the open grill end 106 of the housing 102. One unique aspect of the present invention is that the grill grate 118, which supports the food, is recessed, or offset a predetermined distance from the rim 108 at the grill end 106, so as to protect the food from wind and wind-blown debris.

The housing 102 is further defined by a sidewall 110 that extends between the open ends 104, 106. The sidewall 110 forms the circumferential protective barrier that inhibits the wind and wind-blown debris from contacting the food near the grill end 106, or the heat fuel near the base end 104 of the housing 102. In one embodiment, the housing 102 is about 12″ long and has a diameter of about 13½″. In another embodiment, the housing 102 is fabricated from a noncorrosive or corrosion resistant materials, such as stainless steel, titanium alloys, copper alloys or aluminum.

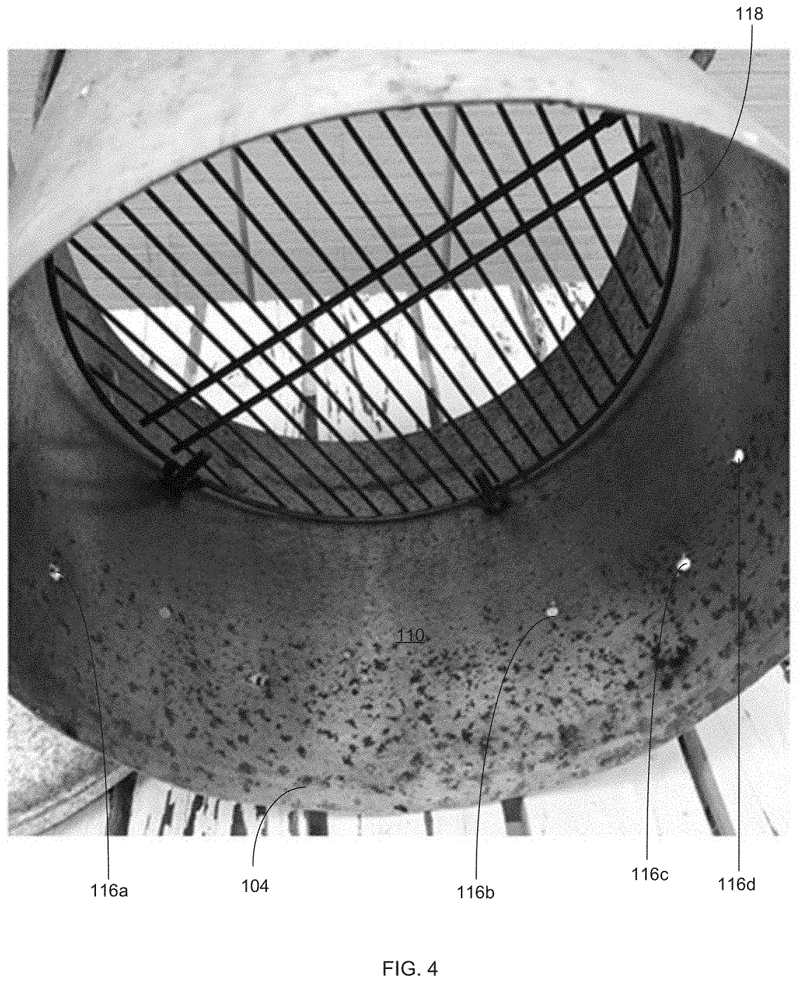

As FIG. 4 shows, the sidewall 110 is defined by a plurality of fastening apertures 112 disposed along different longitudinal positions along the length of the housing 102. The fastening apertures 112, as discussed below, enable a plurality of grate support fasteners 114a-d to pass through for supporting the grill grate 118. In some embodiments, the position of the grill grate 118 in relation to the rim 108 is adjustable depending on the environmental conditions. In one embodiment, different levels of fastening apertures allow the grill grate 118 to be height adjusted along the length of the housing 102. In another embodiment, vertical slots can be formed in the housing 102 through which grate support fasteners 114 a-d extend. Fasteners 114 a-d may be loosened sufficiently to allow the user to raise or lower the grill grate 118 depending on the environmental conditions and then tightened again once the desired level is achieved.

As shown in FIG. 5, the sidewall 110 can also defined by a plurality vent apertures 116a-c that enable passage of air through the sidewall 110. The passage of air creates air circulation through the housing, necessary for dissipating radiated heat through the food. The vent apertures 116a-c are circumferentially disposed around the sidewall 110 to create a uniform flow of air. Additional ventilation features may be present, for example, the grill may be equipped with a lid that substantially covers the opening of housing 102. The lid 120 can comprise vents for controlling the air flow.

In another embodiment, housing 102 comprises a ventilation control assembly. In some embodiments, the ventilation control assembly comprises a plate slidably engaged and conformed to the sidewall 110 and wherein said plate and sidewall 110 further comprise a track assembly for controlled movement of plate across the sidewall surface. As the plate is manipulated by the user and moved along the track assembly, one or more of the vent apertures 116 are opened or closed depending on the position of plate. The same general mechanical concept could be applied to the vents positioned in lid 120 discussed above.

The open base end 104 of the housing 102 concentrically positions over a heating fuel. In this position, the sidewalls direct radiated heat upwardly from the heating fuel towards the grill grate 118 at the open grill end 106 of the housing. The lightweight nature of the portable outdoor grill 100 allows the base end 104 to be easily placed over the ground surface (e.g., a pit, hole or substantially flat surface) containing heat fuel. The heat fuel may include, without limitation, charcoal, briquettes, and wood.

In some embodiments, the portable outdoor grill 100 includes a grill grate 118 for supporting food (FIG. 2). The grill grate 118 may include a flat panel comprising multiple wires in a parallel, spaced apart relationship. The grill grate 118 provides a supportive surface for the food, including various meats and vegetables known in the art of barbequing. Heat from the heat fuel transfers to the food by passing through the grill grate 118. The grill grate 118 is perpendicularly disposed across the sidewall 110, with the perimeter of the grill grate 118 nestled against the sidewall 110 in a snug relationship. In one embodiment, the grill grate 118 is circular in shape to fit within the cylindrical shape of the housing 102.

The grill grate 118 is offset from the rim 108 about one-third of the length of the sidewall 110 from the open grill end 106 of the housing 102. In one non-limiting embodiment, the grill grate 118 is recessed about 4″ from the rim 108, and about 8″ from the open base end 104 (FIGS. 2 and 3). Though in other embodiments, the grill grate 118 may be height adjusted to different positons along the length of the housing 102. In any case, the offset positon within the confines of the sidewall 110 inhibit wind and wind-blown debris from engaging the grill grate 118 and food contained thereon.

In some embodiments, multiple grate support fasteners 114a-d are used to height adjust the grill grate 118 along the length of the housing 102. The grate support fasteners 114a-d pass through the fastening apertures 112 that form in the sidewall 110 to support the grill grate 118. In one embodiment, four gate support fasteners 114a, 114b, 114c, 114d support the grill grate 118 at equidistant positions around the sidewall 110. The grate support fasteners 114a-d may include, without limitation, a bolt, a screw, a nail, and an elongated fastening mechanism.

In some embodiments, a lid 120 detachably covers the open grill end 106 of the housing 102. The lid 120 is sized and dimensioned to cover and seal the opening in the grill end 106, so that the radiated heat and smoke does not escape form the open grill end 106. The lid 120 may completely detach from the grill end 106, or may be provided with hinges attached to the sidewall 110 at the grill end 106 to move between a closed position and an open position.

It is known in the art that in order to open and close the lid 120, it is necessary to place the arm and hand directly over the upper grate, and thereby over the rising heat from the heat fuel. Thus, the portable outdoor grill 100 provides at least one insulated handle 122a-c that attaches to the lid 120, or the sidewall 110, or both, so as to facilitate gripped manipulation of the housing 102. The insulated handle 122a-c may have a U-shape and be insulated by, for example, plastic dipping, or coating (e.g., liquid, rubberized, or plastic dip coating), taping or constructing the handle from a material that does not readily conduct heat.

Alternative embodiments of the portable outdoor grill 100 may include a square, round, or rectangular housing; with lids or no lids; and with vent apertures 116a-c or without vent apertures for heat control. The portable outdoor grill 100 may also be positioned over any type of heat source suitable for grilling, including electrical or gas heat sources.

Furthermore, because of the recessed position of the grill grate 118, accessing the food with a spatula, knife, fork, or other utensil may be difficult. Thus, a Z-shaped spatula facilitates access to the offset grill grate 118. The Z-shape allows the spatula to naturally engage the food while the hand of the cook remains outside the housing 102. Various other Z-shaped handles for other utensils may also be used. Furthermore, in addition to a traditional flat surface of the spatula, a fork for hot dogs and even an articulating tong on the rim 108 of the housing 102 can be used to prevent food from sliding off the spatula during removal from the recessed grill grate 118.

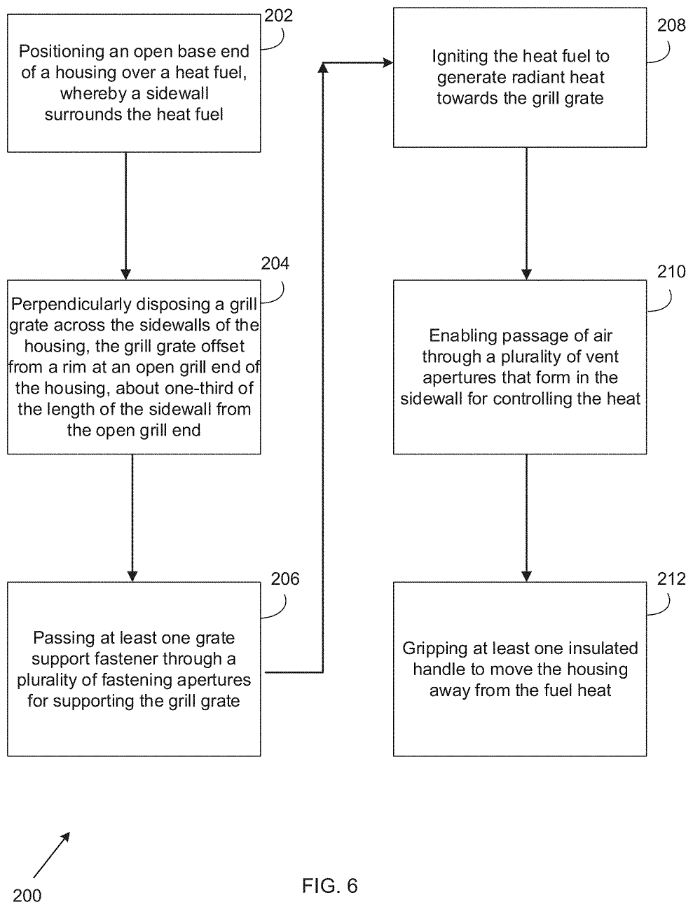

FIG. 6 illustrates a flowchart diagram of an exemplary method 200 for grilling in windy conditions with a portable outdoor grill. The method 200 may include an initial Step 202 of positioning an open base end of a housing over a heat fuel, whereby a sidewall surrounds the heat fuel. The method 200 may further comprise a Step 204 of perpendicularly disposing a grill grate across the sidewalls of the housing, the grill grate offset from a rim at an open grill end of the housing, about one-third of the length of the sidewall from the open grill end, whereby the sidewall surrounds the grill grate.

In some embodiments, a Step 206 includes passing at least one grate support fastener through a plurality of fastening apertures for supporting the grill grate. A Step 208 comprises igniting the heat fuel to generate radiant heat towards the grill grate. A Step 210 includes enabling passage of air through a plurality of vent apertures that form in the sidewall for controlling the heat. In some embodiments, a final Step 212 may include gripping at least one insulated handle to move the housing away from the fuel heat.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A portable outdoor grill, the grill comprising:
a cylindrical housing defined by an open base end and an open grill end terminating at a rim, the housing further defined by a sidewall extending between the open ends, the sidewall defined by multiple fastening apertures disposed along different longitudinal positions along the length of the housing, the sidewall further defined by multiple vent apertures enabling passage of air through the sidewalls,
whereby the open base end of the housing concentrically positions over a heating fuel for directing radiated heat towards the open grill end;
a grill grate perpendicularly disposed across the sidewalls, the grill grate being offset from the rim about one-third of the length of the sidewall from the open grill end of the housing;
multiple grate support fasteners passing through the fastening apertures for supporting the grill grate at different longitudinal positions along the length of the housing;
a lid detachably covering the open grill end of the housing;
at least one insulated handle facilitating gripped manipulation of the portable outdoor grill; and
a generally Z-shaped spatula facilitating access to the offset grill grate.

2. The grill of claim 1, wherein the housing is fabricated from a noncorrosive material.

3. The grill of claim 1, wherein the housing is about 12″ long and has a diameter of about 13½″.

4. The grill of claim 1, wherein the grill grate is 4″ from the rim, and 8″ from the open base end.

5. The grill of claim 1, wherein the fastening and vent apertures are circumferentially disposed around the sidewall.

6. The grill of claim 1, wherein the heating fuel positions in a pit.

7. The grill of claim 1, wherein the heating fuel comprises charcoal.

8. The grill of claim 1, wherein the at least one insulated handle positions on the lid and the sidewall.

9. A method for grilling in windy conditions with a portable outdoor grill, the method comprising:
positioning an open base end of a housing over a heat fuel, whereby a sidewall surrounds the heat fuel;
perpendicularly disposing a grill grate across the sidewalls of the housing, the grill grate offset from a rim at an open grill end of the housing, about one-third of the length of the sidewall from the open grill end, whereby the sidewall surrounds the grill grate;
passing at least one grate support fastener through a plurality of fastening apertures for supporting the grill grate;
igniting the heat fuel to generate radiant heat towards the grill grate;
enabling passage of air through a plurality of vent apertures that form in the sidewall for controlling the heat; and
gripping at least one insulated handle to move the housing away from the fuel heat.
